(19) United States
(12) Patent Application Publication
(10) Pub. No.: US 2020/0063289 A1
(43) Pub. Date: Feb. 27, 2020

(54) ELECTROSPINNING PRINTING DEVICE AND METHOD

(71) Applicant: regenHU AG, Villaz-St-Pierre (CH)

(72) Inventors: Michael Kuster, Liebefeld (CH); Marc Thurner, Wavre (CH)

(21) Appl. No.: 16/500,291

(22) PCT Filed: Apr. 5, 2018
(86) PCT No.: PCT/EP2018/058732

§ 371 Date: Oct. 2, 2019

(30) Foreign Application Priority Data
Apr. 6, 2017 (CH) 00460/17

(51) Int. Cl. D01D 5/00; B29C 64/245; B33Y 10/00

(52) U.S. Cl. CPC D01D 5/0076; B33Y 10/00; B29C 64/245

(57) ABSTRACT

An electrospinning printing device and method thereof are disclosed. The device may comprise: a printing head arrangement configured to replaceably hold at least one printing head for discharging a fibrous material, and a collector arrangement configured to electrostatically attract material from the printing head, in which the collector arrangement may comprise an at least partially electrically insulated collector that is arranged to be connected to an electric power supply, and the at least one printing head is electrically grounded when held by the printing head arrangement.

### FIELD OF THE INVENTION

The present invention relates to an electrospinning printing device for the manufacture of products by way of electrospinning and printing, in particular to 3D printing and to a method for manufacturing by electrospinning printing.

### BACKGROUND OF THE INVENTION

Electrospinning devices are known for the manufacture of fine structures and fibres, such as those contained in filters, clinical products, optoelectronic circuits, photovoltaic devices, energy storage devices and tubular structures. Materials known to be processed by electrospinning include polymer melts and solutions that are electrostatically deposited onto a substrate on an electrostatic collector.

The demand for affordable, reliable and practical electrospinning devices makes it a priority in the industry to provide them with these attributes. In particular, because they operate on electrical power, there is a desire for electrospinning devices that can be easily installed, used and updated using readily available electrical infrastructure, such as that present at the device's installation site.

### SUMMARY OF THE INVENTION

A problem with electrospinning results from the comparatively high voltage generally required for generating an electrostatic field of sufficient strength. This can cause undesired and potentially dangerous electric arcs and sparkovers.

An objective underlying the present invention is to improve the manufacture of printed products via electrospinning, in particular in terms of reliability, practicality and safety.

The objective is achieved generally by means of the subject matter of the independent claims. Exemplary and favourable embodiments are defined by the dependent claims and the overall disclosure.

In an aspect, the objective is achieved by an electrospinning printing device comprising at least one printing head arrangement configured to replaceably hold at least one printing head for discharging fibrous material via electrospinning. In a further aspect, the printing head arrangement is configured to hold at least one printing head for discharging a material other than via electrospinning, whereby said printing head may be the same printing head as one used for electrospinning or it may be a different printing head used for discharging a material other than via electrospinning.

In another aspect, the electrospinning printing device comprises a collector arrangement placed at a distance from the printing head arrangement and which is configured to electrostatically attract and draw out material from the at least one printing head as fibrous material via electrospinning. The collector arrangement comprises an at least partially electrically insulated electrostatic collector configured to be connected to an electric power supply for charging the collector.

In an aspect, the printing head arrangement is designed such that the at least one printing head is electrically grounded when held in the printing head arrangement. In some embodiments, at least a part of the at least one printing head, for example a nozzle or spinneret, is electrically grounded. In some embodiments, the printing head arrangement is itself electrically grounded.

For the purposes of the present document, electrospinning is considered to be a process wherein a material is moved through the printing head arrangement, in particular through the at least one printing head, where it is subjected to an electrostatic field. Where the at least one printing head comprises a nozzle or spinneret, the material in the nozzle or spinneret may be subjected to the electrostatic field. The material for example includes any fluid containing a polymer, such as a polymer solution or a polymer melt. The electrostatic field draws it out of the printing head, nozzle or spinneret as a Taylor cone leading to fibre or multiple fibres formed in the electrostatic field. Fibres drawn out of the at least one printing head are removably deposited on a substrate which is arranged, for example, between the printing head and the collector, and form a printed pattern with nanoscale or microscale structuring. In an embodiment, the fibrous material is deposited on the dielectric or on the collector.

Depending on the sequence with which fibres are drawn out of the at least one or multiple printing heads, the electrospinning may yield a deposition of material comprising multiple layers or areas different from each other in terms of material and material layout.

For the purposes of the present document, an electrospinning printing device refers to a device wherein a printing head and a target, for example a substrate in the collector arrangement, are movable relative to each other, meaning that either the printing head or the target or both are moved in any or all of x-y-z directions, and allow the manufacture or partial manufacture of products by means of drawing material out of a printing head via electrospinning. At the same time, an electrospinning printing device refers to a device having the above relative movability of printing head and target wherein the products are manufactured or partially manufactured by means of direct printing. The electrospinning printing device therefore is also designed to carry out direct printing. The electrospinning printing device accordingly allows the combined manufacturing process including both electrospinning and direct printing. In some embodiments, the printing head and target are moveable relative to each other in a coordinated manner. Electrospinning and direct printing may be carried out simultaneously and/or in an alternating manner. A combination of electrospinning and direct printing allows the manufacture of products of complex geometric structure and highly specific and sophisticated material properties. A field of application is the manufacture of patient-specific biocompatible bodies, such as tissue or bone substitutes.

For the purpose of the present document, direct printing refers to material deposition on a target by mechanically forcing material out of the at least one printing head by exerting a mechanical force, in particular pressure, onto the material by means of a pressure exertion device, for example by means of hydraulic or pneumatic pressure, effected for example by a displaceable piston or an extrusion screw, while moving the printer head and the collector arrangement relative to each other. Direct printing includes 3D-printing, whereby material is deposited on a target in a layered manner. The combination of electrospinning and direct printing can therefore also be understood as the combination of electrospinning and 3D-printing. The material may be deposited continuously as lines or strings, fibrous material and/or may be deposited discontinuously as droplets or islands.

A printing head useable in the printing head arrangement of the electrospinning printing device comprises at least an entry hole for receiving and channelling a material to be discharged, via electrospinning and/or another discharge method such as direct printing, and an exit hole for discharging the material. The entry hole and exit hole may be the entry hole and exit hole of a nozzle or spinneret, respectively.

Materials suitable for printing via electrospinning and/or direct printing can be chosen out of a group including fluids or paste-like materials such polymers, biopolymers, plastics, thermoplastics and peptides.

Because the printing head arrangement and in particular the part of the printing head arrangement surrounding the material to be discharged is electrically grounded, shielding means that shield components against electrostatic interference, electric arcs, sparkovers and the like, in particular components of the electrospinning printing device arranged in or near the printing head arrangement, are not a requirement. Sparkovers and the like between neighbouring printing heads are prevented in embodiments with more than one printing head.

The collector of the collector arrangement may be positively or negatively charged depending on the polarity of the electric power supply. The collector in some embodiments is formed as a plate.

In some embodiments, it comprises steel but it may comprise other conductive materials such as copper or aluminium. In some embodiments, the collector has a thickness of 1.5 to 5 mm. In some embodiments, it is welded, clamped or otherwise firmly joined to a conductor for galvanic coupling with the electric power supply. In some embodiments, the collector comprises a spigot or pin, which may be formed on the side of the collector facing away from the printing head and projects from the centre of the collector, for example. The conductor connected to the collector, for example to the spigot or pin of the collector, in some embodiments is a high voltage power cable.

In some embodiments, a switch is provided between the collector and the electric power supply so that the collector can be connected to or disconnected from the electric power supply. In some embodiments, disconnection means are provided that disconnect the collector from the electric power supply, such as a switch, fuse or circuit breaker.

The electric power supply in some embodiments is a part of the electrospinning printing device. Alternatively, it is provided separately. It may provide a voltage in a range of, for example 0.1 kV to 100 kV, for example between 1 kV and 30 kV. Voltages up to 500 kV may be preferred in some embodiments. In some embodiments, the power is tapped from a transformer substation or from an on-site regional power grid connection. The voltage may be fixed or adjustable in accordance with the material and the manufacturing process. The electric power supply may be designed as an AC and/or DC power supply and may be switchable for activation or deactivation.

As mentioned before, the electrospinning printing device is also operable without electrospinning or applying an electrostatic field. For example, a manufacturing process can be carried out whereby material is electrospun out of the at least one printing head, followed by and/or alternating with material deposition without the electrostatic field, for example by disconnecting the collector or switching off the power supply and then direct printing, in particular extruding or microextruding, the same or other material.

Electric insulating means or a dielectric are applied on the collector to at least partially cover its surface, in particular the surface of the collector facing the printing head, more particularly an edge of the collector. When applied to an edge of the collector, the dielectric may be “wrapped around” the edge, i.e. it may at least partially cover the edge surfaces of the collector and the actual edge to which they converge. Alternatively, the dielectric may form an outer ring on the surface of the collector facing the printing head arrangement, wherein the outer ring covers an outer region and the edge of the collector. In some embodiments, the dielectric fully covers the surface of the collector facing the printing head arrangement, whereby in some embodiments it extends beyond the edge of the collector, i.e. the dielectric applied on the collector may have an area larger than the surface of the collector facing the printing head arrangement. Dielectric materials found to be advantageous in terms of dielectric strength and mechanical strength are preferred and include glass, quartz glass, and transparent or opaque ceramic, opaque white ceramic, soda lime glass. In some embodiments, the dielectric is at least partially transparent. It was found that this reveals any cracking of the collector, thereby facilitating safety and quality inspection. In some embodiments, the dielectric has a resistivity between 103 to 108 Ωm and/or a dielectric constant r between 3.5 and 8, for example.

In some embodiments, the electrical insulating means contains material with low or lowered polarizability. It may include fewer polar bonds, carbon, fluorine, hydrocarbons, heat-resistant polymers, and/or be porous.

The collector arrangement according to some embodiments comprises a substrate on which the material discharged from the at least one printing head is deposited. The substrate may have a surface from which the fibrous material can be easily removed, such as a polished surface. Substrates found to be advantageous are a microscope object glass or a Petri dish. The substrate is arranged between the at least one printing head and the collector, for example on the collector and/or on the dielectric.

The collector arrangement according to some embodiments of the electrospinning printing device comprises a tray which houses the collector and any additional components of the collector arrangement. The collector and any additional components of the collector arrangement such as the dielectric and/or the substrate are in some embodiments removably mounted in the tray. The tray may have an annular form with the opening positioned in the path of the ejected fibrous material. The collector may be mounted on the inner edge of the annular tray. The collector may fully or partially cover the opening of the annular tray. The tray is in some embodiments made of or primarily contains plastic or aluminium, for example. In some embodiments, the side of the collector facing away from the printing head is at least partially covered with a resin, for example an epoxy resin, further improving its mechanical resilience against dielectric breakdown.

Because the collector is arranged in the electrospinning printing device to be easily accessible to a user for extracting of the printed product, the dielectric also can easily be put on the collector and replaced whenever necessary. Because the collector is placed at a distance from the printing head arrangement, in the event of a breakdown voltage overcoming the dielectric strength of the dielectric, electrically sensitive components in or near the printing head arrangement are at a safer distance from any discharge regions on the collector such as its edges and are therefore less likely to be damaged.

Advantageously, an operator can interact with the printed product while the electrospinning is taking place because the collector is at least partially covered with the electrical insulator and therefore hinders sparkovers. The operator may therefore unload and load printed products or product parts during electrospinning, for example when a mesh is being electrospun on a metallic implant, thereby avoiding interrupting the electrospinning process when the metallic implant is being exchanged. The electrospinning process can remain active and does not need to be restarted including the time needed for tailor cone formation at the spinneret.

In some embodiments, the electrospinning printing device comprises at least one electrically grounded printing head held by the printing head arrangement. The at least one printing head may be disposable or reusable.

In some embodiments, the at least one printing head installable in the printing head arrangement comprises at least one nozzle or spinneret for electrospinning, whose exit hole corresponds to and is considered to be an exit hole of the printing head. In some embodiments, the at least one spinneret or nozzle is disposable, meaning that it can be attached to and detached from the printing head. In some embodiments, the at least one nozzle or spinneret comprises at least a hollow needle from which the material is discharged. The hollow needle may extend longitudinally inside another outer hollow needle or tubular element to form a coaxial spinneret comprising coaxial channels. A coaxial nozzle or spinneret for electrospinning may allow a material, in particular a fluid, to move through its inner channel or outer channel and it may allow a gas to flow through its outer channel. When discharging a material from its outer channel, the at least one nozzle or spinneret may produce tubular fibrous material. A coaxial nozzle or spinneret for electrospinning may be partially coaxial wherein the inner and outer channels merge near the exit hole of the spinneret, allowing the material, in particular the fluid and/or gas to mix prior to exiting the spinneret. In some embodiments of the nozzle or spinneret for electrospinning, a number of hollow needles arranged next to each other may extend longitudinally inside a common outer hollow needle to form a multichannel spinneret. In some embodiments, a printing head comprises a plurality of spinnerets for electrospinning in the manner of a showerhead for simultaneously discharge of a plurality of fibres stemming from a common material reservoir, in particular a fluid reservoir. The spinnerets themselves can be a combination of any of the above mentioned spinnerets to advantageously provide a discharge pattern configurable to a wide variety of desired printed products. A needle part of the spinneret or nozzle or the entire spinneret or nozzle for electrospinning from may be electrically conductive.

In some embodiments, a printing head comprises at least one nozzle for direct printing, in particular for extruding or microextruding material in the absence of an electrostatic field, such as when the electric power supply is switched off or the collector is disconnected from the electric power supply. The exit hole of the printing head corresponds to the exit hole of the nozzle for direct printing. In some embodiments, the at least one nozzle for direct printing is disposable, meaning that it can be attached to and detached from the printing head. The at least one nozzle for direct printing may be a coaxial, partially coaxial, multichannel or showerhead nozzle or a combination thereof in the manner of the spinneret embodiments described above. The nozzle for direct printing may have a cross section different, in particular larger than the nozzle or spinneret for electrospinning. The at least one nozzle for direct printing may comprise a different material than and/or have a different electrical conductivity than the nozzle or spinneret for electrospinning. When used alternatingly or simultaneously with the nozzle or spinneret for electrospinning, a hybrid product comprising electrospun fibrous material and microextruded material can be obtained. For example, a layered structure comprising layers of biomaterial on top of layers of polymer material can be obtained.

In some embodiments, the nozzle for electrospinning and the nozzle for direct printing are one and the same. In some embodiments, the nozzle for electrospinning and the nozzle for direct printing are separate and part of different printing heads.

In some embodiments, the printing head arrangement is designed to simultaneously hold a plurality of printing heads. The printing head arrangement may comprise a printing head selector, such as a selector wheel or a selector sliding carriage, comprising a holder for receiving and retaining the printing heads, the holder being adjustable to move a selected printing head into a printing position. The selector sliding carriage for example includes linear slides on which the printing heads are mounted. In some embodiments, printing heads not selected for printing are kept at a further distance from the collector. The holder may be configured to move, for example robotically, any printing head into a non-printing position away from the electrostatic field and vice versa.

In some embodiments, the printing head arrangement is provided with a temperature control device for controlling the temperature of the material to be discharged from a printing head.

Because a high voltage is not applied to the printing head arrangement, it may be designed with separate circuitry and/or a separate electrical power supply, for example a low voltage power supply dedicated to the temperature control device irrespective of the high voltage applied to the collector.

In some embodiments, the temperature control device comprises a heating device comprising a heat source that may be provided as an electrically resistive heating wire pattern. Current supplied by the electrical power supply flows through the resistive heating wire pattern, thereby heating it. Alternatively, the heat source may comprise a Pelletier element. The heat is conducted through at least a part of the printing head arrangement and is transferred to the material prior its discharge from the printing head.

In some embodiments, the temperature control device comprises a thermofluid circuit or a Pelletier element for heating and/or cooling the material to be discharged.

Temperatures targeted for the material discharged from a printing head in some embodiments lies in a range of between 5 and 400 C and in some embodiments between 5 and 250 C. For certain materials, the target temperature range may lie between 250 and 400 C.

In some embodiments, the at least one printing head of the printing head arrangement is provided with a heating device in the manner described above, for example as an electrically resistive wire pattern or as a heating patch for heating the material in the printing head to a temperature desired for electrospinning. In the case of a heating patch, according to some embodiments, the heating wire pattern is provided on a thermally conductive sheet provided with an adhesive or other mechanical coupling means for fixing the patch to the printing head. In particular, the nozzle or spinneret of the at least one printing head may be provided with said heating device on its outer surface(s).

In some embodiments, the electrospinning printing device comprises at least one reservoir containing a material to be discharged from the at least one printing head. In some embodiments, the printing head arrangement is configured to receive and retain the reservoir. Alternatively, the reservoir is arranged outside of the printing head arrangement. In some embodiments, the reservoir comprises a cartridge. The reservoir may be disposable or reusable. The reservoir is configured to be placed in connection, for example by means of a connecting member, with the at least one printing head. The reservoir may be mechanically coupled to or arranged at a distance from the at least one printing head. In some embodiments, the reservoir may be arranged in the printing head arrangement adjacent the printing head and feed into it via the connection member, such as via an appropriate fluid opening between the reservoir and the printing head. Alternatively, the reservoir is arranged at a distance from the printing head and feeds into it via the connection member, such as via a rigid or a fluid connection such as a flexible tube.

In some embodiments, the movement of material between the reservoir and the printing head can be interrupted, for example while a printing head is being selected, removed and/or installed. The movement of material between the reservoir and the printing head can be enabled when a printing head has been installed, selected and/or brought into a printing position. The interruption or enablement of the material movement between the reservoir and the at least one printing head is realised, according to some embodiments, by the connection member being provided with a valve which opens or closes the flow of the material from the reservoir to the printing head. Where a valve is provided, material such as a fluid contained in the reservoir may have a low viscosity, such as a polymer gel.

In some embodiments, a plurality of reservoirs containing different materials to be discharged from one or a plurality of printing heads are arranged in or outside the printing head arrangement. Each reservoir may be assigned to a specific printing head, meaning that each reservoir is connected, via a connection member, to only one printing head to allow movement of material from only this reservoir into this printing head. For example, one reservoir may contain a material for electrospinning while another reservoir contains a material for direct printing. In some embodiments, a plurality of reservoirs are assigned, each via a connection member, to a single printing head. For example, a reservoir containing a fluid and a reservoir containing a gas such as air, may each be connected via a connection member to the single printing head. The printing head will then receive different materials and discharge their product.

In some embodiments, a reservoir is assigned to a plurality of printing heads, meaning that the reservoir is connected via a plurality of connection members to a plurality of printing heads to allow movement of material from the reservoir into each of the plurality of printing heads.

In some embodiments, the at least one reservoir and the at least one printing head are provided as separate units or may be provided as a combined reservoir-printing head unit installable into a corresponding space in the printing head arrangement. The reservoir, printing head and/or the combined reservoir-printing head unit may each be reusable or disposable one-way products, such as a disposable cartridge, used for manufacturing a single product or structure, for example a single tissue substitute. In some embodiments, a plurality of such combined reservoir-printing head units are accommodated in the printing head arrangement. The at least one reservoir and the at least one printing head of the combined reservoir-printing head unit, each as described in this document, are in some embodiments fixedly or detachably connected to each other with a connection member provided between them allowing material to move from the reservoir to the printing head. A printing head and/or a reservoir may be manually exchanged for another, put together as a reservoir-printing head unit and installed in the printing head arrangement. The optional printing head selector is in some embodiments configured with means for receiving and retaining the reservoir-printing head units, such as a holder or a selector wheel, for example.

In some embodiments, the at least one printing head or reservoir-printing head unit securely contacts the electrical ground when it is brought into a position for printing. An electrical contact or terminal on the ground side and/or on the printing head side may be provided by contact pads. Where the printing head comprises a nozzle or spinneret, the spinneret or nozzle itself may be the contact or comprise a contact pad.

In some embodiments, pressure can be applied to the material to be discharged from a printing head by a pressure exertion device. This may be the case for a material for electrospinning or a material for direct printing. The pressure exertion device can include a plunger pushing the material toward the printing head, whereby the plunger head may be contained in a reservoir or a plurality of plunger heads may be contained in a plurality of reservoirs. The plunger may be moved by an electric plunger motor controlled by a computer instructed by a computer program for driving the motor. Alternatively, the pressure may be exerted by air pressure generated in an air pump controlled by a computer instructed by a computer program for driving the air pump. The air pump may be connected to each and any reservoir by means of rigid or flexible channels. In a further alternative, the pressure is exerted by means of an extrusion screw driven by an extrusion screw motor. The pressure exertion device may be part of the electrospinning printing device or may be provided fully or partly distinct therefrom.

In some embodiments, the collector arrangement and the at least one printing head are movable relative to each other, for example in a plane perpendicular to the discharge direction of the fibrous material, for example by means of a positioning system. Preferably, the positioning system is in operative coupling with at least one of the printing head arrangement and/or the collector arrangement. In an embodiment in which a positioning system is operatively coupled with the collector arrangement, said positioning system may be suitable for positioning the collector arrangement in a plane essentially perpendicular to the exit vector of the fibrous material discharged from a printing head. In an embodiment in which a positioning system is operatively coupled with the printing head arrangement, said positioning system may be suitable for positioning the printing head arrangement in a plane essentially perpendicular to the exit vector of the fibrous material discharged from a printing head. The positioning system can be designed, for example, as an x-y stage. The x-y stage according to some embodiments comprises a number of guide rail arrangements, of which a lower guide rail arrangement enables displacement of a load placed on it in the x-direction. The load is mounted on a load carrier of the lower guide rail arrangement which is displaced by means of a linear motor comprising a system of permanent magnets and conductive coils, for example. The load on the lower guide rail arrangement itself comprises an upper guide rail arrangement of the x-y stage comprising a collector arrangement carrier that is slidably mounted on the upper guide rail arrangement. The collector arrangement carrier similarly may be displaced by means of a linear motor. Sliding the load carrier of the lower guide rail arrangement and sliding the collector arrangement carrier enables the collector arrangement to be moved into any position of x-y plane. In further embodiments of the positioning system, a spindle drive with a threaded spindle and a drive nut is provided, in combination with motors, such as DC motors or stepper motors. Rotatory and/or linear encoders may be present for providing position feedback.

In some embodiments, the positioning system is designed to allow spatial positioning in all three spatial directions x, y, z, with z indicating the exit vector of the material leaving the printing head, typically corresponding with the direction of gravity. Such positioning system may be realized as x-y-z stage, for example. Alternatively, the collector arrangement or collector arrangement carrier is mounted on an x-y stage and the printing head arrangement is mounted on a further linear stage. In some embodiments, the x-y-z stage is employed for 3D printing.

In some embodiments, the collector arrangement is positioned underneath the printing head relative to the force of gravity. This is not always a requirement, however, because the electrostatic field generated and the flow of the fibrous material in this field easily overcome gravitational force. In some embodiments, therefore, the collector arrangement is positioned above the printing head arrangement.

In some embodiments, a computer for controlling the relative positioning of the collector arrangement and the printing head arrangement is provided. Rotary and/or linear encoders and/or optical sensors provide the computer with position feedback, for example. A computer program installed on the computer can be configured to process the feedback and provide output signalling that controls the positioning system to a desired position at which fibrous material may be released from a printing head. The computer program may include a module for controlling the printing head selector, if provided, so as to bring a selected printing head into position suitable for printing. In some embodiments, the computer program and the computer control the electric power supply. Alternatively or additionally to a computer running corresponding program code, the corresponding functionality may be fully or partly realized by dedicated circuitry.

In some embodiments, an electronic control unit comprising dedicated circuitry, for example, is provided for controlling the positioning of the collector arrangement. It receives feedback and instructs the collector arrangement to move in the manner described above for the computer and computer program, including an embodiment where the dedicated circuitry includes a module for printing head selection. In some embodiments, the control unit also controls operation of a temperature control device and/or a pressure exertion device as explained before. Further, the control unit may be designed to control operation of the electric power supply, such as switching on/off and/or adjusting the voltage and/or waveform of the supplied voltage. The control unit may be realized by a combination of hardware components and/or a computer running a corresponding computer program.

Nanofibres produced via electrospinning may have a thickness between 0.1 μm and 20 μm and microfibers produced via electrospinning or via direct printing, in particular extrusion or microextrusion, may have a thickness between 60 μm and 1000 μm.

The material to be electrospun or direct printed can be chosen out of but not limited to the group: organic material, polymer melt, polymer solution, bio-ink, hydrogel, thermoplastic, calcium phosphate paste. Suitable polymer melts were found to include polyethylene glycol blends, low density polyethylene, polyactide, polyethylene co-vinyl alcohol, polypropylene. In some embodiments, a polymer solution is used for printing finer structures than those produced with a polymer melt. A bio-ink suitable for use in the described electrospinning printing device is a fluid-like material that contains living cells in a matrix that can be printed into specific shapes, for example an implant with a personalized shape or a tissue construct for drug testing. The bio-ink can be direct printed and combined with the fibrous material electrospun out of a polymer melt to produce a compound product comprising an ultra-fine and durable mesh on which biomaterial is laid for growth. Fibrous material electrospun out of calcium phosphate paste may be used as a bone substitute. In addition or alternatively, the bio-ink may be electrospun and deposited on the printing substrate provided sufficiently low voltages and temperatures are applied preventing the damage of biological structures.

Because the electrospinning printing device provided comprises a printing head and/or printing head arrangement electrically grounded while the collector is charged and at least partially covered with a dielectric, any combination of any embodiment of printing head, reservoir, spinneret, nozzle, sensor, electric field strength and voltage, collector, dielectric and positioning system described in this document is technically more viable due to the stable and safe electrical environment provided. Because the printing heads and/or the printing head arrangement used for electrospinning are electrically grounded, they can be used with printing heads for direct printing without cumbersome electromagnetic shielding means separating them. Apart from operational safety, the stable electrical environment improves reproducibility and control of the released fibrous material, thereby allowing structures to be repeatedly printed according to detailed specifications.

The foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed. The words used in the specification are words of description rather than limitation, and it is understood that various changes may be made without departing from the spirit and scope of the invention.

According to another aspect, the overall objective underlying the present invention is achieved by a method for manufacturing a product, in particular a biocompatible body or tissue substitute, by electrospinning. The method includes providing at least one electrically grounded printing head and an at least partly insulated collector that is connected to an electric power supply, such that an electrostatic field is established between the printing head and the collector. The method further includes electrospinning whereby material is drawn out of the printing head via the electrostatic field and fibrous material discharged from the printing head is deposited on a substrate. The method includes moving the printing head and the collector relative to each other, in particular in a coordinated manner during the material deposition.

In some embodiments, the method includes direct printing, whereby a material is pressured and discharged out of the at least one printing head without electrospinning. Such direct printing may be carried out simultaneously or alternately with the electrospinning, in particular while the printing head and the collector are moved relative to one another as described.

A method in accordance with the present disclosure may in particular be carried out with an electrospinning printing device in accordance with the present disclosure. Specific embodiments of the electrospinning printing device disclose, at the same time, corresponding embodiments of the method, and vice versa.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1 is a schematic diagram of an electrospinning printing device comprising an electrically grounded printing head arrangement and a collector arrangement,

FIG. 2 is a simplified perspective image of a collector arrangement wherein the edge of a collector is covered with a ring-shaped dielectric,

FIG. 3 is a simplified perspective image of a collector arrangement wherein the surface of the collector facing the printing head is fully covered with a dielectric plate,

FIGS. 4a to 4b schematic diagrams of different spinnerets,

FIG. 5 is a schematic diagram of a printing head arrangement comprising a plurality of printing heads movable in x-y-z directions and a collector arrangement movable in x-y-z directions

FIG. 6 shows a printed mesh consisting of alternating layers of an electrospun polymer melt fibre and microextruded meander-like bio-ink fibre

FIG. 7 shows a magnified section of a hybrid product produced by the present electrospinning printing device

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

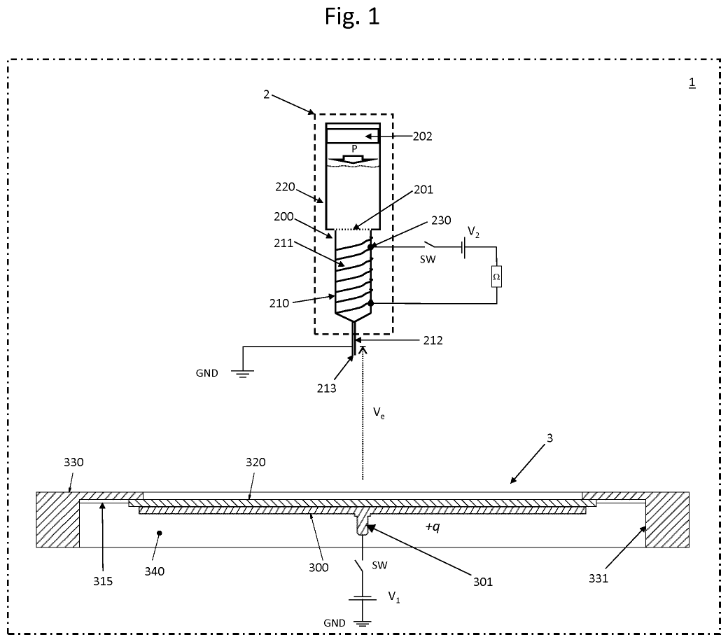

FIG. 1 schematically shows an electrospinning printing device 1 comprising a printing head arrangement 2 and a collector arrangement 3, wherein the collector arrangement 3 comprises a collector 300 connected to a regulated power supply V₁ provided by a power supply unit which preferably is grounded GND. The electrical connection between the collector 300 and the power supply V₁ can optionally be enabled or disabled by operating a switch SW provided in an electrical circuit of which the collector and the power supply are components. Specifically, the switch SW may take the form of an on/off switch. Alternatively, the switch SW may constitute a disconnection means such as a fuse or circuit breaker for protecting the collector and associated parts of the collector arrangement and the printing head arrangement against overvoltage.

The printing head arrangement 2 comprises a reservoir 220 containing a material suitable for electrospinning and a printing head 200 comprising a spinneret 210 along with connection means 201 in the form of a fluid opening connecting the two (shown schematically with a dotted line). The printing head 200 and the reservoir 220 are shown joined together as a reservoir-printing head unit in the form of a cartridge. It is to be understood, however, that they can be provided as separate units, for example in the form of cartridges, and that they can be joined together or held at a distance from one another in the printing head arrangement. The material in the reservoir can be a fluid comprising a polymer, such as a polymer melt. The spinneret 210 of the printing head 200 comprises a generally electrically conductive tubular housing 211 and one end comprising an opening 201 configured to receive the material from the reservoir 220 and another end comprising an exit hole 213 which is pointed at the collector arrangement 3 and from which the material being electrospun is discharged. The spinneret 210 includes a hollow needle 212 for discharging the fluid from the exit hole 213 which generally corresponds to the exit hole 213 of the printing head 200. The hollow needle 212 section and in particular the exit hole 213 have a diameter typically between 60 μm and 2 mm, preferably between 100 and 500 μm. The spinneret contacts the electrical ground GND via its housing 211 and/or the hollow needle 212. Instead of comprising a single opening 201 or a single exit hole 213, however, spinnerets comprising multiple openings 201 and/or multiple exit holes 213 as shown in FIG. 4 can be used.

Controlling or tempering the fluid to a desired temperature for electrospinning is achieved by an optional temperature control device, here shown to be a heating device arranged in or on the printing head. Specifically, the heating device comprises a heating coil 230 wrapped around a part of the spinneret 210 of the printing head through which the fluid flows. The heating coil is shown to be wrapped around the housing 211 of the spinneret but it may also be wrapped around the hollow needle section 212 of the spinneret. It is to be understood that the temperature control element does not necessarily have to contact the spinneret. It may instead contact another part of the printing head as long as the temperature of the material to be discharged can be controlled. Indeed, the temperature control device may contact the reservoir 220, for example a housing of the reservoir. The heating coil 230 is a resistor element with resistance Ω that provided in a circuit having a regulated power supply V₂. This circuit is preferably separate from the circuit comprising the collector 300, i.e. it is electrically decoupled from the circuit of the collector 300, which can be accomplished by electrically insulating the heating coil from the circuitry of the printing head 2 leading to the ground GND. Although a heating coil 230 is described here as a heating device for heating the fluid, another heating device can be used, such as a Pelletier element, a thermofluid circuit, a heating jacket, sleeve or patch wrapped around the housing 211 and/or the hollow needle section 212 of the spinneret 210.

Depending on the material to be discharged, the temperature control device has a cooling function. To this end, a Pelletier element and/or a thermofluid circuit can be applied to the spinneret 211.

The reservoir 220, which can be provided as a cartridge, comprises a pressure exertion device 202 for pressuring the material with a pressure P to exit the reservoir and enter the spinneret 210. The material contained in the reservoir 220 may be a fluid with a lower or higher viscosity as needed. It may also be a paste-like material. The exit end of the reservoir mated with the spinneret may comprise valve means such as a membrane that is punctured by a needle or formed at the material-receiving end of the spinneret, in particular for fluid with low viscosity such as a hydrogel. The pressure exertion device 202 may for example be carried out as a plunger or piston whose axial displacement is effected by an electric motor which may itself be part of the pressure exerting device or distinct therefrom.

In this way, the reservoir has the function of a syringe that pushes the material into the spinneret. The plunger of the reservoir is axially displaced by means of an electric motor, whereby the plunger comprises a threaded shaft that engages with a threaded rotating counter element driven by the electric motor. The reservoir 220 may optionally contain a sensor to measure its filling level and returns this information to a computer and a computer program which controls the electric motor. Alternatively, the filling level of the reservoir 220 may be determined, starting from a given initial filling level, by determining the plunger displacement directly or indirectly, for example by way of counting motor revolutions. Alternatively, the pressure exertions means 202 may include a pneumatic or hydraulic pressure device, such as an air pump that charges the plunger with a pneumatic force, or the fluid may be directly pneumatically charged and thereby pressurized.

The collector arrangement 3, of which a section is shown, comprises a collector plate 300 with a spigot 301 arranged centrally on the lower face of the collector 300. The shape and size of the collector plate 300 is chosen to match the size of the printable (working) area. Typically, it may be disc-shaped or rectangular. The material of the collector is preferably chosen to have good electrical conductivity, and to that end preferably contains steel, brass, copper or aluminium.

As an electrical insulator, a dielectric plate 320 such as a ceramic plate in the present embodiment fully covers the upper surface of the collector and has lateral dimensions greater than the collector 300 it covers. The dielectric plate 320 is fixed or glued onto the collector, for example by means of silicone or double-sided tape.

The underside of the collector arrangement 3 is covered with an epoxy resin providing it with its final mechanical stability. Instead of an epoxy resin, however, another material may be used such as a potting compound containing polyurethane or silicone. For example, a 2-K polyurethane compound may be used such as the product PUR 5620-A/5610-B of Astorit AG. As a suitable silicone material, K-silicone compounds may be used such as the product ELASTOSIL RT 428 with WACKER® CATALYST T 77 2 of Wacker Chemie AG.

Viewed from the spinneret 210, the collector 300 is hidden from sight by the dielectric plate 320. Instead of a ceramic plate 320, a glass plate may be used. A transparent dielectric plate has the advantage that any cracks in the plate would be easily identified. Whichever material is used for the dielectric plate, it should not electrically charge easily and should be structurally resilient against overcurrent at breakdown voltages beyond the voltage V₁, e. g. up to 30 kV, preferably of up to 120 kV, and also against physical shock such as when colliding with a hard object. The dielectric plate 320 preferably has a thickness of about 2 mm, thicker if voltages over 30 kV are applied.

Dielectric plate types with the following physical and electrical characteristics were found to be suitable:

| | | | | | Relative |
|---|---|---|---|---|---|
| | | Thickness | Dimensions | Resistivity | permittivity |
| Material | Type | (mm) | (cm × cm) | (Ω · m) | (εᵣ) |
| Heraeus HOQ 300 | Glass | 2.14 | 15.70 × 9.80 | 10⁸ | 3.7 (0 to |
| Quartz Glass | Rough | | | (400° C.) | 1000 MHz, |
| | | | | | 24° C.) |
| Thermo Fisher | Glass | 2.08 | 14.95 × 10.05 | n/a | 7.2-7.8 |
| Electroverre-Glas | Smooth | | | | |
| Soda-Lime Glass | | | | | |
| SCHOTT Nextrema ™ | Nextrema | 1.98 | 13.00 × 7.00 | 10⁸ | 7.8 (1 MHz, |
| Transparent Ceramic | Clear | | | (350° C.) | 25° C.) |
| 724 - 8 | | | | | |
| SCHOTT Nextrema ™ | Nextrema | 2.20 | 13.00 × 7.00 | 10⁸ | 6.6 (1 MHz, |
| opaque white ceramic | White | | | (350° C.) | 25° C.) |
| 724 - 8 | | | | | |

The collector arrangement 3 further comprises a holder 330 in the form of a tray in which the collector 300 and the dielectric plate 320 are mounted. The tray 330 is shaped as an annular disk wherein the edge of the dielectric plate 320 is mounted on the face 315 of the inner edge of the disk facing away from the printing head arrangement 2. The dielectric plate 320 may be glued onto said inner edge face. The outer edge of the tray 330 is defined by a wall 331 surrounding the inner space of the tray and extends away from the printing head arrangement 2. The space below the collector 300 enclosed by the wall 331 is filled with an epoxy resin 340 with high mechanical resilience against dielectric breakdown. Suitable exemplary epoxy resins were found to be: Araldite™ CW 229-3 and Aradur™ HW 229-1. The tray 330 can be made of plastic or aluminium or it may contain these materials as primary components. The space above surface of the dielectric plate 320 facing the printing head arrangement 2 is kept free for an uninterrupted line of sight between the exit hole 213 of the spinneret 210 and the dielectric plate 320. A high voltage cable connects the spigot 301 of the collector plate 300 to a grounded electric power supply V₁ so that the collector plate can be negatively or positively charged depending on the polarity of the power supply. A switch SW is preferably provided to enable or disable electrical connection of the power supply V₁ from the collector arrangement where needed.

When the power supply V₁ is turned on, the collector 300 becomes positively (or negatively) charged and an electrostatic field with a potential drop of Vₑ is created between the electrically spinneret 210 and the collector plate 300. The spinneret 210, in particular its hollow needle 212, then carries a charge opposite to that of the collector plate 300 and current flows from the tip of the hollow needle to the ground. At the same time, pressure P is applied to the fluid contained in the cartridge 220 by means of the plunger 202 according to the foregoing description and pushes the fluid through the heated section of the spinneret 210 to the exit hole 213 of the hollow needle 212 where the electrostatic field draws it out and onto the dielectric plate 320 where a printed pattern is created.

Because the spinneret 210 discharges to ground, any equipment of the printing head arrangement 2 surrounding the spinneret is a lesser source of electrical interference to the spinneret. As a result, it was found that turbulent whipping behaviour of fibrous material discharged from the spinneret could be reduced. This in turn facilitated a controlled printing process. Furthermore, because the collector 300 is connected to the power supply V₁ and charged and the components of the electrospinning printing device in the immediate neighbourhood of the collector would be subject to electrical discharge emanating from the collector, protecting them against said discharge is facilitated by the dielectric plate 320 which can be mounted on the collector 300 which is easily accessible to the user.

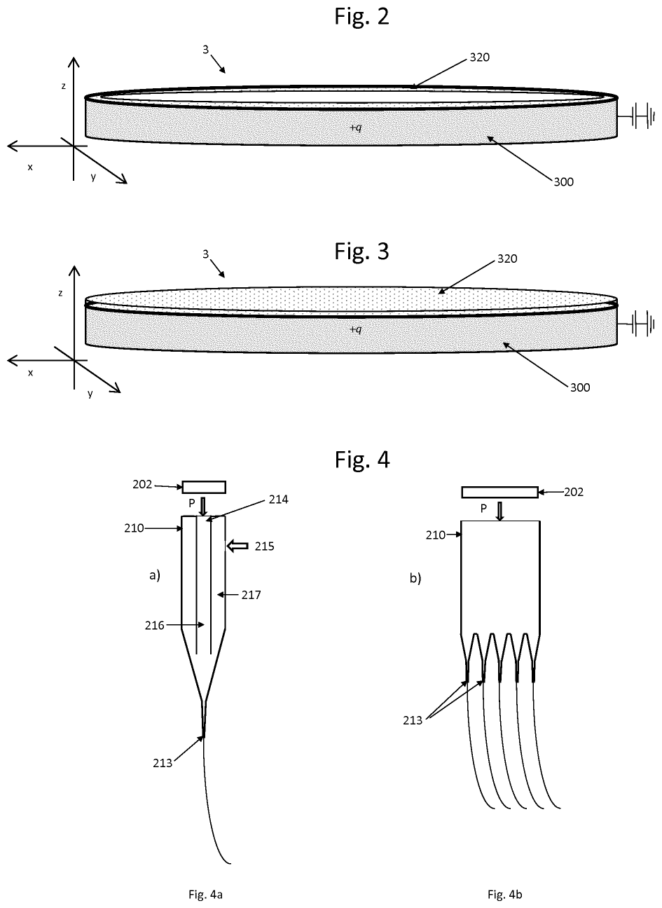

FIG. 2 is a perspective view onto a collector arrangement 3 comprising a collector plate 300 having a charge +q and dielectric material 320 applied to the surface of the collector plate facing the printing head 2 in the edge region of the collector plate. The dielectric material creates a ring covering the edge of the collector plate 300. The upper surface of the dielectric ring 320 can be glued on to the edge region of the tray of the collector arrangement according to the foregoing description and the lower surface of the dielectric ring 320 can be glued to the edge region of the collector plate. The dielectric ring 320 prevents electric discharge from the edge region of the collector plate 300.

FIG. 3 is a perspective view onto a collector arrangement 3 comprising a collector plate 300 having a charge +q and dielectric material 320 applied to the entire surface of the collector plate facing the printing head 2 in the manner described for FIG. 1. The dielectric plate 320 not only prevents electric discharge from the edge region of the collector 300, but also from the inner surface of the collector plate facing the printing head 2 when sufficiently high voltages are reached or the dielectric material has been compromised or damaged.

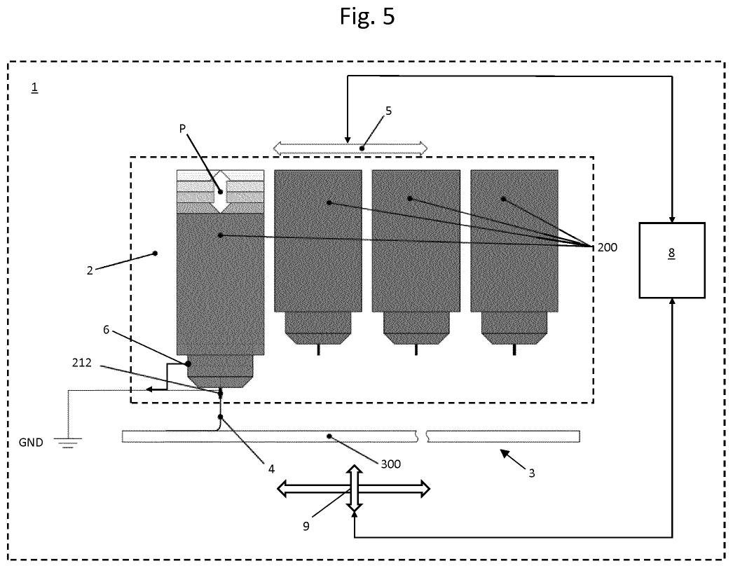

The collector arrangements 3 are mounted on an x-y stage movable in the x-y plane perpendicular to the exit vector of the fibrous material from the spinneret (shown schematically in FIG. 5). Moving the x-y stage enables progressive deposition of the fibrous material ejected from the spinneret to create a desired pattern. An x-y stage controllable by a computer and a computer program and/or by a control unit can be used where an upper stage on which the collector arrangement is slidably mounted is itself slidably mounted on a lower stage, whereby the collector arrangement is displaceable at a right angle to the upper stage. The displacing movements are controlled by spindle drives. Instead of the x-y stage, and x-y-z stage may be used on which the collector arrangement 300 is mounted for positioning it in any of the 3 spatial directions. Such a positioning system may be advantageously be used in 3D printing.

FIG. 4 shows a number of possible spinneret or printing head designs for use in the presently described electrospinning printing device.

FIG. 4a schematically shows a coaxial spinneret comprising two entries or openings 214 and 215 leading into coaxial fluid channels, each fluidically connected to a different reservoir or source. One opening 214 may be provided at the upper end of the spinneret leading to the inner channel 216 whilst the other opening 215 may be provided in the side of the spinneret leading into the outer channel 217. The fluid channels merge at the bottom of the spinneret where the fluids they have channelled mix. Alternatively, the inner 216 and outer channel 217 may extend separately to the exit hole 213 so that a fibrous material exiting the spinneret 210 may consist of a core surrounded by a sheath, the core material being different than the sheath material. The coaxial spinneret 210 may alternatively receive a fluid and a gas via the openings, whereby the gas flows into the outer channel 217 of the coaxial spinneret via the side opening 215. The gas can be used for a number of purposes, including: stretching the fibrous material exiting from the inner channel, prevention of clogging, lowering its viscosity or, if a polymer solution is used, increasing the evaporation rate of the solvent. Furthermore, only the outer channel 217 need be used with a fluid if, for example, a tubular fibrous material is to be released from the spinneret.

FIG. 4b schematically shows a spinneret 210 comprising one fluid channel receiving a fluid shown by the down arrow P and plurality of exit holes 213 for simultaneously releasing a plurality of strands of fibrous material.

FIG. 5 schematically shows an embodiment on a printing head arrangement 2 comprising a plurality of printing heads 200 movably mounted on a printing head selector. The printing heads 200 may be provided separately from reservoirs or they may be joined to reservoirs (not shown) as is the case here. At least one of the printing heads 200 is configured for electrospinning and comprises a spinneret 210. Any other printing head 200 of this printing head arrangement 2 may be configured for direct writing and comprises at least one nozzle for ejecting material provided in a reservoir under pressure P. A suitable direct printing material would be a bio-ink, for example. The printing heads 200 are brought into position by a printing head selector comprising linear slides on which the printing heads are mounted, shown schematically with arrow 5, the linear slides being activated by a motor, solenoid or pneumatically. Active printing heads are in a lower position closer to the collector 300 than non-active printing heads in a higher position further away from the collector. Preferably, only one printing head is active at a time. Alternatively, as a printing head selector, a robotic printing head exchanger such as a selector wheel may be provided. Printing heads not used are preferably kept away from the working area to avoid collision and to bring them out of the exposure to the electrostatic field.

When a printing head 200 is lowered into a position for electrospinning, it engages a schematically shown electrical contact 6 provided in the printing head arrangement 2 for connecting it to the electrical ground GND. In particular, the electrical contact 6 engages with the spinneret or nozzle of the printing head 200. This ensures that every printing head 200 for electrospinning that is brought into a discharge position is electrically grounded. Alternatively, however, all printing heads 200 for electrospinning are permanently electrically grounded. Printing heads not used can be kept further away from the electrostatic field and pressure exertion means 202 (see FIGS. 1 to 3) are not activated so no material feeds into these printing heads. Because a printing head 200 for electrospinning may in some embodiments also be used for direct printing, it is to be understood that a printing head 200 for direct printing may also be brought into contact with electrical contact 6. However, printing heads 200 not configured for electrospinning, such as printing heads used for direct printing only, in particular microextrusion, can be brought into a separate printing position where no electrical grounding takes place. These printing heads 200 may be configured for direct printing and deposition of polymers or bio-inks.

The electrospinning printing device 1 further includes a control unit 8 that may be realized by a computer running a corresponding computer program, dedicated circuitry or a combination thereof. The control unit is designed to control the power supply of the electrospinning printing device. The control unit is further designed to control the pressure P for exerting a pressure on the material in the reservoir or reservoirs to be discharged from the printing head or printing heads via electrospinning and/or direct printing simultaneously and/or in an alternating manner. Although not shown in this drawing, pressure P may be exerted on the material by a pressure exertion device such as pressure exertion device 202 shown in FIGS. 1 and 3. The control unit 8 is further designed to control the movement of the collector arrangement 3 by way of a stage as described further below in a coordinated manner with the deposition of material on the substrate. If the temperature control device is present, the control unit may further be designed to control its operation.

The control unit in some embodiments is designed to coordinate the material deposition by way of electrospinning and/or applying a mechanical force, and the movement of the collector arrangement 3 such that a workpiece of defined geometry, for example a tissue substitute, is realized. The control unit may be designed to receive and/or store the workpiece geometry in form of numeric data, in particular in form of a CAD and/or CAE model.

A computer program installed on a computer controls the positioning of all printing heads 200 by controlling the printing head selector such as a selector wheel according to the desired printed product. The computer may be realised as a control unit 8 which may be integrated in the electrospinning printing device with corresponding operator interfaces or may be separated from the electrospinning printing device but connected to it via dedicated fixed-line or wireless communication channels. Part or all of the control functionality may also be realized by way of a control unit with dedicated circuitry. The control unit 8 instructs different printing heads 200 releasing different fibrous material to alternately be brought into printing positions in accordance with the desired layered structure of the product to be printed. The printing heads 220 of the printing head arrangement 2 may comprise different spinnerets or nozzles according to the foregoing description, or they may all be the same.

FIG. 5 also schematically shows and x-y-z stage 9 for positioning the collector arrangement in any of the 3 spatial directions. The constitution of the x-y-z stage 9 is described in the general part of the description of this document.

Whilst the x-y or x-y-z stage 9 and the control unit exemplarily are shown to be a part of the electrospinning printing device 1, at least one of them may alternatively be provided separately and connected to an electrospinning printing device described in this document that does not comprise positioning means for the collector arrangement and/or a control unit.

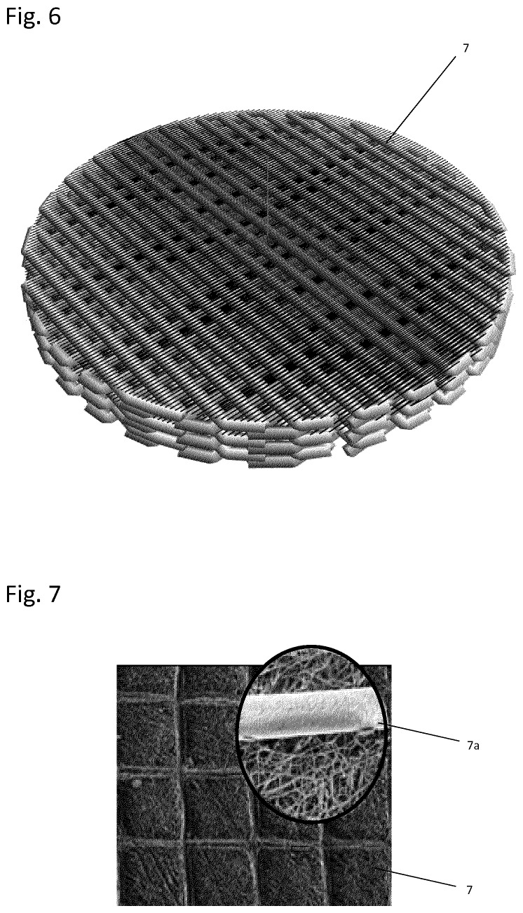

FIG. 6 shows a perspective view onto a printed product 7 produced with an electrospinning printing device 1 according to an embodiment described in this document, wherein a printing head 200 configured for electrospinning was brought into a position for electrospinning a polymer melt, resulting in the meander-like deposit of nanoscale fibrous material on a layer of the meander-like deposit of microscale fibrous material. The nanoscale fibrous material is electrospun out of a polymer melt, whereas the microscale fibrous material is microextruded out of a bio-ink. It is to be understood that not only can nanoscale and the microscale fibrous material be printed alternately in a layered structure, but that nanoscale and microscale fibrous material can also be deposited as part of one and the same layer of a layered structure or as part of single sheet. The deposited nanoscale fibrous strands have a thickness between 0.1 and 20 μm whereas the deposited microscale fibrous strands have a thickness between 60 μm and 1000 μm. The hybrid product as depicted with this figure may comprise artificial cartilage tissue, for example.

FIG. 7 shows a section of another hybrid printed product. The magnified section 7a of the image reveals a fine-mesh substrate in the background covered with thicker strands. The fine mesh-substrate is manufactured via electrospinning and the thicker strands via direct printing, in this case via 3D printing. The thicker strands have a thickness of ca. 200 μm and the fibres of the electrospun fibrous material in the background have thickness of ca 6 μm. Both materials derive from polycaprolactone (PCL) that can be contained in a reservoir, moved to a printing head and discharged therefrom by electrospinning with a grounded printing head and a charged collector, followed by direct printing, in particular 3D printing, where the same or another printing head extrudes the polycaprolactone in the absence of the electrostatic field when the collector is not charged.

### LIST OF DESIGNATIONS

1 Electrospinning printing device
2 Printing head arrangement
200 Printing head
201 Connection means
202 Pressure exertion means
210 Spinneret
211 Spinneret housing
212 Spinneret nozzle/hollow needle
213 Spinneret exit hole
214 Spinneret end face opening
215 Coaxial spinneret side face opening
216 Coaxial spinneret inner channel
217 Coaxial spinneret outer channel
230 Spinneret heating device
3 Collector arrangement
300 Collector plate
301 Spigot
315 face of inner edge of disk-shaped tray 330
320 Dielectric plate
330 Tray
331 Wall of tray
340 Potting material
4 Fibrous strand
5 Printing head selector
6 Electrical ground contact
7 Printed product
7a Magnified section of printed product
8 Control unit
9 Positioning means for collector arrangement
GND Electrical ground
V₁ Voltage applied to collector plate
Vₑ Electrostatic potential difference between collector plate and spinneret
V₂ Voltage applied to heating device
SW Switch
P Pressure exertion

1. An electrospinning printing device, comprising:
a printing head arrangement configured to replaceably hold at least one printing head for discharging a fibrous material; and
a collector arrangement configured to electrostatically attract material from the printing head, wherein the collector arrangement comprises an at least partially electrically insulated collector that is arranged to be connected to an electric power supply, and the at least one printing head is electrically grounded when held by the printing head arrangement.

2.-14. (canceled)

15. A method for manufacturing a biocompatible body or tissue substitute, by electrospinning, the method comprising:
providing an electrically grounded printing head and an at least partly electrically insulated collector that is connected to an electric power supply, such that an electrostatic field is established between the printing head and the collector; and
simultaneously and/or alternatingly drawing material out of the printing head via the electrostatic field and moving the printing head and the collector relative to each other.

16. (canceled)
